(19) United States
(12) Patent Application Publication
(10) Pub. No.: US 2026/0196852 A1
(43) Pub. Date: Jul. 9, 2026

(54) METHOD FOR CONTROLLING AN ENERGY STORAGE SYSTEM TO INFLUENCE THE BALANCING OF THE SYSTEM

(71) Applicant: FLUENCE ENERGY, LLC, Arlington, VA (US)

(72) Inventors: Brett Lance Galura, Vienna, VA (US); Thomas Jeffrey Winter, Decatur, GA (US)

(73) Assignee: FLUENCE ENERGY, LLC, Arlington, VA (US)

(21) Appl. No.: 18/867,903

(22) PCT Filed: Sep. 20, 2024
(86) PCT No.: PCT/US2024/047650

§ 371 Date: Nov. 21, 2024

Related U.S. Application Data
(60) Provisional application No. 63/539,928, filed on Sep. 22, 2023.

(51) Int. Cl. H02J 7/52; H01M 10/42; H01M 10/48; H02J 7/00; H02J 7/82

(52) U.S. Cl. CPC H02J 7/52; H01M 10/425; H01M 10/482; H02J 7/82; H02J 7/875; H01M 2010/4271; H01M 2220/10; H02J 2207/20

(57) ABSTRACT

An energy storage system comprises an energy storage node that includes a plurality of battery storage elements and a control subsystem to receive battery data from the battery storage elements. The energy storage system further includes a power conversion system (PCS) and a control system coupled to the energy storage node and the PCS. The control system, the control subsystem, or both are configured to: receive or store battery charge and discharge characteristics of the battery storage elements during a plurality of operating conditions of the battery storage elements, the PCS, or both; and run the battery storage elements of the energy storage node at one or more selected operating conditions of the plurality of operating conditions based on the battery charge and discharge characteristics to reduce an imbalance in state of charge among the battery storage elements of the energy storage node.

### CROSS-REFERENCE TO RELATED APPLICATIONS

This application claims priority to U.S. Provisional Patent Application No. 63/539,928, filed on Sep. 22, 2023, titled “Method for Controlling an Energy Storage System to Influence the Balancing of the System,” the entire disclosure of which is incorporated by reference herein.

### TECHNICAL FIELD

The present subject matter relates to energy storage systems that include a plurality of energy storage nodes and receiving or storing battery charge and discharge characteristics of battery storage elements during a plurality of operating conditions of the battery storage elements, a power conversion system (PCS), or both. The present subject matter also encompasses running the battery storage elements of an energy storage node at one or more selected operating conditions based on the battery charge and discharge characteristics to reduce an imbalance among the battery storage elements of the energy storage node.

### BACKGROUND

An energy storage system, such as a battery energy storage system (BESS), can be set up in a distributed manner to satisfy safety and economical concerns. The energy storage system often includes many energy storage nodes that each include an enclosure that houses many batteries inside. Typically, the energy storage system includes a control system that monitors the energy storage nodes.

Generally, the components of the battery energy storage system can have a diversity of states of charge (SOC) as the systems cycle through charging and discharging. In some examples, part of an energy storage system may be discharging while another part of the system is charging or idle, in order to meet the needs of the customer and the electrical grid. Further, within the energy storage systems, various sub-elements, such as the battery cells included in battery modules, the battery modules included within battery racks, the battery racks included in battery cubes, the battery cubes included in battery cores, and the battery cores included in battery arrays, may have varying SOCs among one another due to prior usage patterns of those components as well as due to manufacturing and maintenance variability.

Varying SOCs among electronic components at a given level (battery cells, battery modules, battery racks, etc.) are problematic because all of the battery cells in a given battery module tend to need to operate together as a unit. Consequently, a battery rack can only perform as well as its lowest-performing battery module, and a battery module can only perform as well as its lowest-performing battery cell. In the context of SOC, the worst-performing sub-component within a component is the sub-component with the lowest charging ceiling, as well as the sub-component with the highest discharging floor. These could be the same sub-component, or these could be two separate sub-components. When these sub-components substantially deviate from their component or super-components expected SOC behavior, the component or super-component is considered out-of-balance or misbalanced.

A misbalanced energy storage system can therefore incur massive performance costs, as the energy storage system may only perform as well as its worst sub-component at charging or discharging. Traditionally, misbalancing is identified manually, generally by noticing a pattern of reduced system or component-wide performance, and then by investigating on a per-component or sub-component basis to identify problematic components and sub-components.

Misbalance is a widely acknowledged issue in battery systems. Historically, once the misbalanced components are identified, however, the process for balance correction is also less than ideal. Historically, these misbalances have been addressed through either active or passive balancing. Passive balancing, the more common of the approaches, “bleeds off” the energy from system elements (battery racks, battery modules, battery cells) that are identified as being at a higher state of charge, to bring higher energy elements back in line with the rest of the system. One disadvantage with this passive balancing approach is that such “bled off” energy is lost and is not usable by the energy storage system. Active balancing, a less common approach, feeds energy from one part of the energy storage system identified as being at a higher state of charge, to another part of the energy storage system identified as being at a lower state of charge. One disadvantage associated with this active balancing approach is additional power conversion hardware to support the shuttling of power from one part of the energy storage system to another.

Current state of the art energy storage systems are lacking in several respects in reducing imbalance. First, the energy storage systems have limited awareness or observation of misbalances existing or developing between the various elements. Second, state of the art energy storage systems have no analysis or algorithm which identifies ways to control the system via component control or system biasing to reduce the misbalances. Third, current state of the art energy storage systems do not execute commands to put adaptive measures in place for misbalances.

### SUMMARY

The node balancing technologies herein can reduce imbalance among battery storage of an energy storage node via operational biasing during a normal operation of an energy storage node or running during a maintenance operation. The node balancing technologies influence the balancing of the energy storage system, without the use of conventional active or passive balancing methods. Balancing here includes reducing differences in states of charge between various battery storage elements of the energy storage node, such as battery racks, battery modules, or battery cells. These misbalances may be observed and substantiated as differential states of charge or differential voltages of the energy storage node.

The node balancing technologies can observe or determine such misbalances, such as by applying one or more balancing models. The one or more balancing models can identify ways to control the energy storage system to reduce an imbalance among the battery storage elements of the energy storage node. In one example, power commands can then be dispatch to the energy storage node to reduce the imbalance.

Reducing imbalances in state of charge in an energy storage system has several benefits. Primarily, reducing imbalances lowers the amount of stranded energy in the energy storage system. Stranded energy is energy that is stored but cannot be accessed due to the fact that another component or sub-component of the energy storage system reached a relatively weaker discharge limit before the component or sub-component storing the inaccessible energy reaches a relatively stronger discharge limit. Reducing stranded energy across an energy storage system allows more work to be done and more energy to be provisioned with the same amount of battery. This potentially reduces the capital cost of the energy storage system as well as reducing the need for the capital costs associated with augmenting of the energy storage system with enhanced capacity as the energy storage system ages.

Similarly, imbalances in the state of charge can limit the amount of energy an energy storage system can store (energy capacity) because a component or sub-component of the energy storage system has reached a charge limit before the rest of the energy storage system. This limited energy capacity incurs a similar impact on capital cost as the stranded energy.

Reducing imbalances in the state of charge can also reduce faults in the energy storage system related to battery racks falling offline. As battery racks move to very low states of charge, the most out-of-balance battery racks disconnect from the rest of the energy storage system via a disconnection fault. These disconnection faults have historically been a driver of reactive service activities and their associated costs. Reducing such disconnect faults would lower service costs, reduce risks of financial penalties related to underperformance, and improve customer satisfaction.

In a first example, an energy storage system 101 includes an energy storage node 105A. The energy storage node 105A includes a plurality of battery storage elements 106A-N, and a control subsystem 110 to receive battery data 111A-N from the battery storage elements 106A-N. The energy storage system 101 further includes a power conversion system (PCS) 104; and a control system 115 coupled to the energy storage node 105A and the PCS 104. The control system 115, the control subsystem 110, or both are configured to receive or store battery charge and discharge characteristics 390A-N of the battery storage elements 106A-N during a plurality of operating conditions 391A-N of the battery storage elements 106A-N, the PCS 104, or both. The control system 115, the control subsystem 110, or both are configured to run the battery storage elements 106A-N of the energy storage node 105A at one or more selected operating conditions 391A of the plurality of operating conditions 391A-N based on the battery charge and discharge characteristics 390A-N to reduce an imbalance in state of charge 116A among the battery storage elements 106A-N of the energy storage node 105A.

In a second example, a non-transitory computer-readable medium, 313, 353 includes node balancing programming 330A-B. Execution of the node balancing programming 330A-B by one or more processors 312, 352 configures one or more controllers 110, 115, 170-173 to receive or store battery charge and discharge characteristics 390A-N of a plurality of battery storage elements 106A-N of an energy storage node 105A during a plurality of operating conditions 391A-N of the battery storage elements 106A-N, a power conversion system (PCS) 104, or both. Execution of the node balancing programming 330A-B by one or more processors 312, 352 configures one or more controllers 110, 115, 170-173 to run the battery storage elements 106A-N of the energy storage node 105A at one or more selected operating conditions 391A of the plurality of operating conditions 391A-N based on the battery charge and discharge characteristics 390A-N to reduce an imbalance in state of charge 116A among the battery storage elements 106A-N of the energy storage node 105A.

In a third example, a method 600, includes receiving or storing battery charge and discharge characteristics 390A-N of a plurality of battery storage elements 106A-N of an energy storage node 105A during a plurality of operating conditions 391A-N of the battery storage elements 106A-N, a power conversion system (PCS) 104, or both. The method 600 further includes running the battery storage elements 106A-N of the energy storage node 105A at one or more selected operating conditions 391A of the plurality of operating conditions 391A-N based on the battery charge and discharge characteristics 390A-N to reduce an imbalance in state of charge 116A among the battery storage elements 106A-N of the energy storage node 105A.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1A depicts a system that includes an energy storage system, energy system, and an electrical application.

FIG. 1B depicts a battery array, an array controller, and core controllers of an example architecture of a control system of FIG. 1A.

FIG. 1C depicts the array controller, the core controllers, node controllers, and enclosure controllers in the example architecture of the control system of FIGS. 1A-B.

FIG. 1D depicts a power conversion system of a battery core of FIG. 1A-C.

FIG. 2A illustrates a first energy storage node of a plurality of energy storage nodes of the energy storage system of FIGS. 1A-C coupled to the electrical application.

FIG. 2B illustrates a first energy storage node that includes a plurality of battery cubes and a plurality of power conversion systems coupled to a DC link (DC bus).

FIG. 3A is a high-level functional block diagram of the energy storage system of FIG. 1A that depicts components of the control system and control subsystem for node balancing of the energy storage system.

FIG. 3B is another high-level functional block diagram of the energy storage system of FIGS. 1B-C that depicts components of the control system with various controllers for node balancing of the energy storage system.

FIG. 3C is a block diagram of the control system depicting various types of battery conditions to implement the node balancing protocol of FIGS. 4A-B.

FIG. 4A is a node balancing protocol for the energy storage system of FIG. 1A that is implemented by the control system, the control subsystem, and the plurality of energy storage nodes.

FIG. 4B is the node balancing protocol for the energy storage system of FIGS. 1B-C that is implemented by the various controllers of the control system and the plurality of energy storage nodes.

FIG. 5 is a cutaway view of the first energy storage node of the plurality of energy storage nodes and shows details of a plurality of battery storage elements.

FIG. 6 is a flowchart of a method that can be implemented for node balancing of the energy storage system.

### Parts Listing

100 System
101 Energy Storage System
102 Energy System
103 Electrical Application
104, 104A-N Power Conversion Systems
105A-N Energy Storage Nodes
106, 106A-N Battery Storage Elements
107, 107A-N Power Conversion Subsystems
108 Transformer
109 Energy Source
110 Control Subsystem
111A-N Battery Data
112 Required Power Flow
115 Control System
116A-O Battery Conditions
116A, 316A-N State of Charge (SOC)
120 Physical Space
122 Current
123 Voltage
125 Power Bus
150 Battery Array
151A-N Battery Cores
152 Power Conversion Unit
153 HVAC Equipment
154 Fan
155 Condenser
156 Heater
157A-N PCS Data
160 PCS Controller
161 Network Communication Interface
162 Processor
163 Memory
164A-N Environmental Sensors
165A-N Environmental Condition Data
168A-N PCS Sensors
170 Array Controller
171, 171A-N Node Controllers
172, 172A-N Core Controllers
173, 173A-N Enclosure Controllers
174 Market Dispatch Unit Controller
183, 183A-N Power Commands
205 Power Inverter
210 Rectifier
215 DC-DC Converter
225 DC Link (DC Bus)
230, 230A-N Battery Cubes
250 DC Link Voltage
305, 305A-N Network
311, 351 Network Communication Interface
312, 352 Processor
313, 353 Memory
315A-N Sensors
330, 330A-B Node Balancing Programming
365A-N Environmental Condition Data
370A-N Environmental Sensors
375A-N Battery Sensors
380A-N System Data
381A-N Component Data
390A-N Battery Charge and Discharge Characteristics
391A-N Operating Conditions
392 Normal Operation
393 Operational Bias
394 Maintenance Operation
395A-N Balancing Models
398A-N Time Periods
399A-N Operating Condition Patterns
400 Node Balancing Protocol
500 Enclosure
600 Method

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

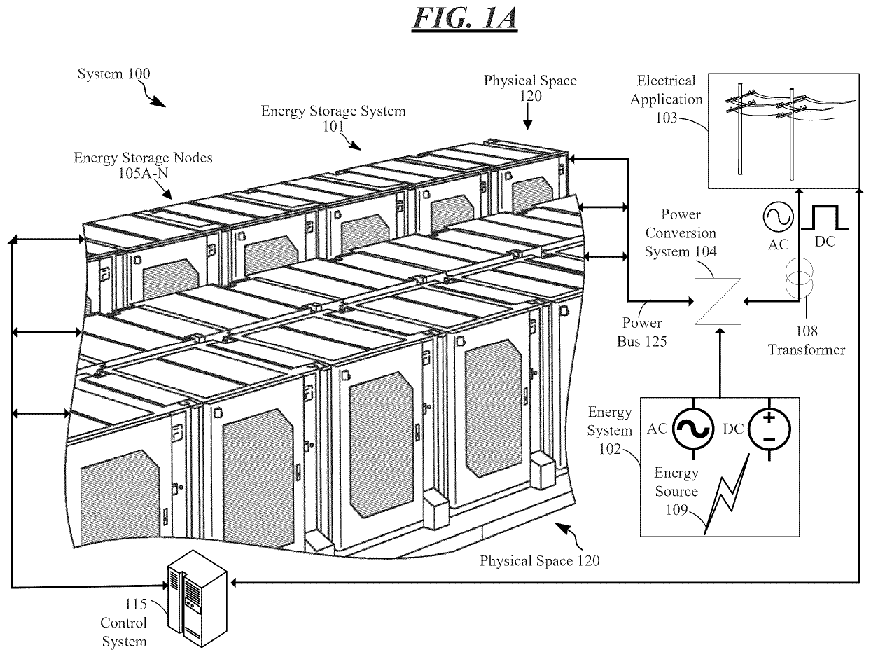

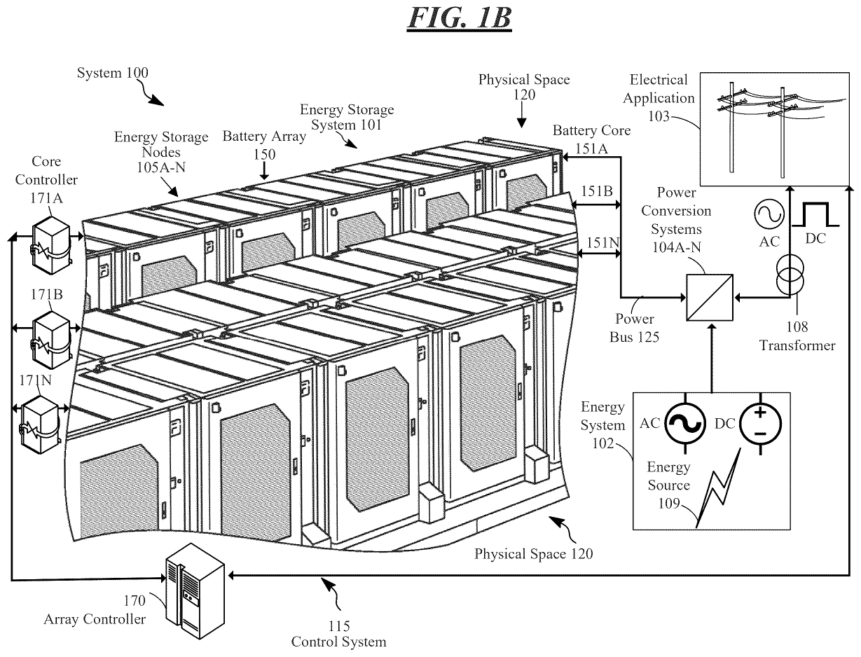

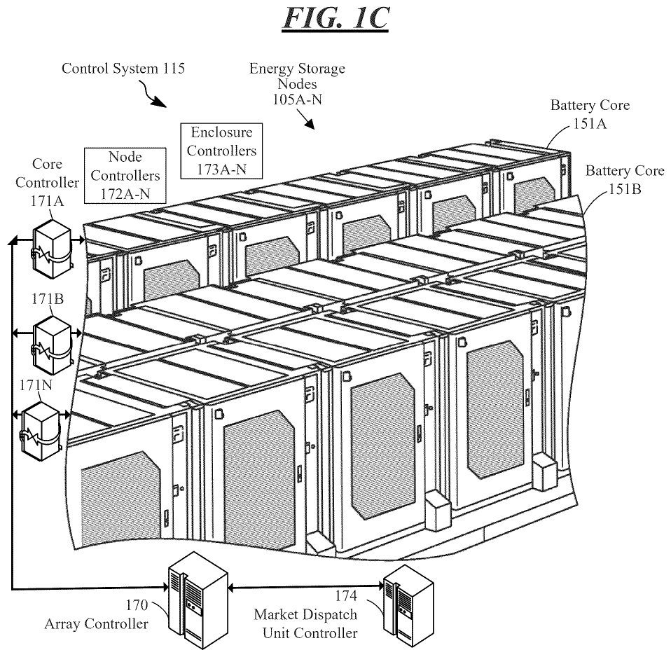

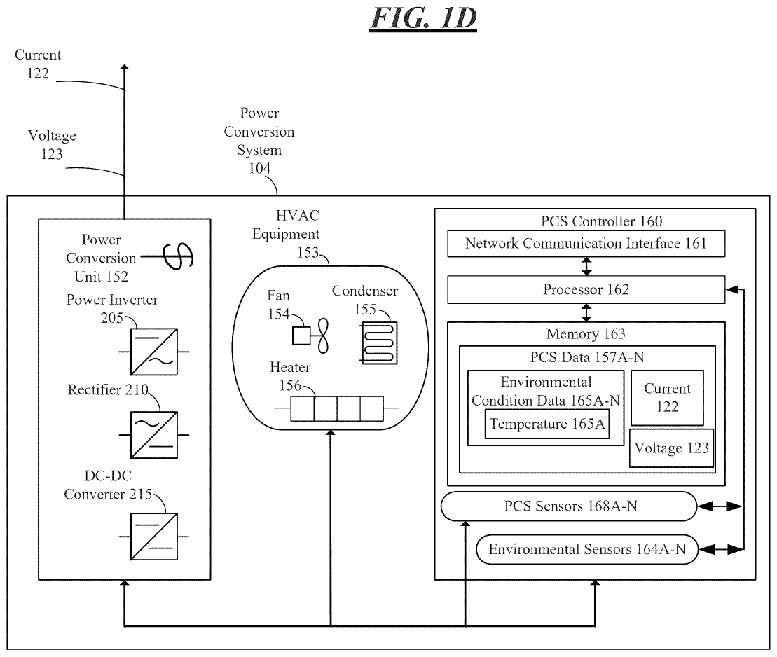

Unless otherwise indicated, any embodiment can be combined with any other embodiment. In particular, FIGS. 1A-6 and the associated text are all combinable with each other.

The term “coupled” as used herein refers to any logical, physical, electrical, or optical connection, link or the like by which electricity, power, signals, or light produced or supplied by one system element are imparted to another coupled element. Unless described otherwise, coupled elements or devices are not necessarily directly connected to one another and may be separated by intermediate components, elements, or communication media that may modify, manipulate or carry the electricity, power, signals, or light.

The orientations of the system 100, energy storage system 101, energy storage nodes 105A-N, associated components, and/or any complete devices, incorporating battery storage elements 106A-N, such as batteries, such as shown in any of the drawings, are given by way of example only, for illustration and discussion purposes. In operation for a particular energy storage application, an energy storage node 105A-N may be oriented in any other direction suitable to the particular application of the energy storage system 101, for example upright, sideways, or any other orientation. Also, to the extent used herein, any directional term, such as left, right, front, rear, back, end, up, down, upper, lower, top, bottom, and side, are used by way of example only, and are not limiting as to direction or orientation of any energy storage system 101 or energy storage nodes 105A-N; or component of an energy storage system 101 or energy storage nodes 105A-N constructed as otherwise described herein.

Unless otherwise indicated, any coupled electrical components can be linked in series or in parallel. In the case of energy storage nodes 105A-N or battery storage elements 106A-N, the components may be linked in series, in parallel, or a combination thereof depending upon a state of a switch or a submodule.

Reference now is made in detail to the examples illustrated in the accompanying drawings and discussed below.

FIG. 1A depicts a system 100 that includes an energy storage system 101, energy system 102, and an electrical application 103. FIG. 1B depicts a battery array 150, an array controller 170, and core controllers 171A-N of an example architecture of a control system 115 of FIG. 1A.

Referring to both FIGS. 1A-B, for example, the energy storage system 101 can be a battery energy storage system (BESS). The energy storage system 101 is coupled to the energy system 102 and the electrical application 103. Energy storage system 101 can include one or more power conversion systems (PCSs) 104A-N, a plurality of energy storage nodes 105A-N, an optional transformer 108, and a control system 115. Components of the energy storage system 101 can be located at a physical space 120 that is outdoors or indoors, for example, inside of a building, a container, or other structure.

Energy storage system 101 comprises a battery array 150 including a plurality of battery cores 151A-N including a first set of battery cores 151A-C and a second set of battery cores 151D-F, for example. Each of the battery cores 151A-N include at least one power conversion system 104A-N. In an example, there can be one PCS 104 and one transformer 108 per battery core 151A-N (at the battery core level).

As described in further detail below, energy storage system 101 can include a control system 115 coupled to the energy storage nodes 105A-N and the PCS 104. The control system 115 can include one or more controllers 170-174, such as an array controller 170, core controllers 171A-N, node controllers 172A-N, enclosure controllers 173A-N, and a market dispatch unit controller 174. The control system 115 is configured to control the battery cores 151A-N to dispatch a required power flow 112.

Power conversion systems 104A-N are coupled to the plurality of energy storage nodes 105A-N. The power conversion systems 104A-N are coupled to the energy system 102 and the electrical application 103 to provide a required power flow 112 to the electrical application 103 by discharging the plurality of energy storage nodes 105A-N or the required power flow 112 from the energy system 102 for charging the plurality of energy storage nodes 105A-N. The power conversion systems 104A-N can be coupled to an optional transformer 108. The optional transformer 108 can step up or step down the required power flow 112 to and from the electrical application 103, such as an AC voltage.

Energy system 102 can include any suitable system for producing electrical energy from an energy source 109. Energy system 102 can be a renewable energy system in which the energy source 109 can be replenished. Such a renewable energy source 109 can include solar power, wind power, geothermal power, biomass, and hydroelectric power. For example, the renewable energy system 102 can be implemented as an array of photovoltaic modules. The photovoltaic (PV) modules can include crystalline silicon, amorphous silicon, copper indium gallium selenide (CIGS) thin film, cadmium telluride (CdTe) thin film, and concentrating photovoltaic which uses lenses and curved mirrors to focus sunlight onto small, but highly efficient, multi-junction solar cells. In another example, the energy system 102 can include wind turbines or gas turbines. In some examples, the energy system 102 can be a non-renewable energy system in which the energy source 109 includes a non-renewable energy source, such as a fossil fuel.

Electrical application 103 can include an electrical grid, such as a power grid, or a smaller local load, such as a backup power system, for a facility such as a hospital, manufacturing site, residential home, or other suitable facility. The electrical application 103 may deliver AC or DC power for on-grid or off-grid applications, including commercial, industrial, or residential applications. The electrical application 103 may deliver power to buildings, electric vehicle charging stations, etc., including a variety of electrical loads that consume AC or DC electric power. The electrical application 103 can be a front-of-the-meter system that is owned or operated by a utility company or a behind-the-meter system that directly supplies buildings and homes with electricity.

Energy source 109 can be a renewable energy source, such as solar power and wind power, which can be intermittent and less reliable compared to fossil fuels. To improve resiliency, energy storage system 101 can store energy from the energy system 102 when the production from the energy source 109 is high. Later on, the energy storage system 101 can dispatch the energy to the electrical application 103 when demand is high or production from the energy source 109 is not keeping up with demand. Moreover, events may occur when a connected load or an operating demand load of the electrical application 103 is excessive or there is electrical grid instability, such as during extreme weather. By storing energy from the energy source 109 and then dispatching the energy during such events, the energy storage system 101 can continue to dispatch a required power flow 112 of the electrical application 103.

Energy storage nodes 105A-N include battery storage elements 106A-N. The battery storage elements 106A-N can be: (1) a single battery cell; (2) a cell grouping, including several battery cells in parallel configuration; (3) a battery submodule or module, including several battery cells in parallel and serial configuration; (4) a battery string, including several battery modules in series; (5) a battery bank, including several battery strings in parallel; (6) other known energy storage elements; and/or (7) a combination thereof. For example, the battery storage elements 106A-N can include a plurality of batteries of any existing or future reusable battery technology, including, but not limited to lithium ion, flow batteries, or mechanical storage, such as flywheel energy storage, compressed air energy storage, pumped-storage hydroelectricity, gravitational potential energy, or a hydraulic accumulator.

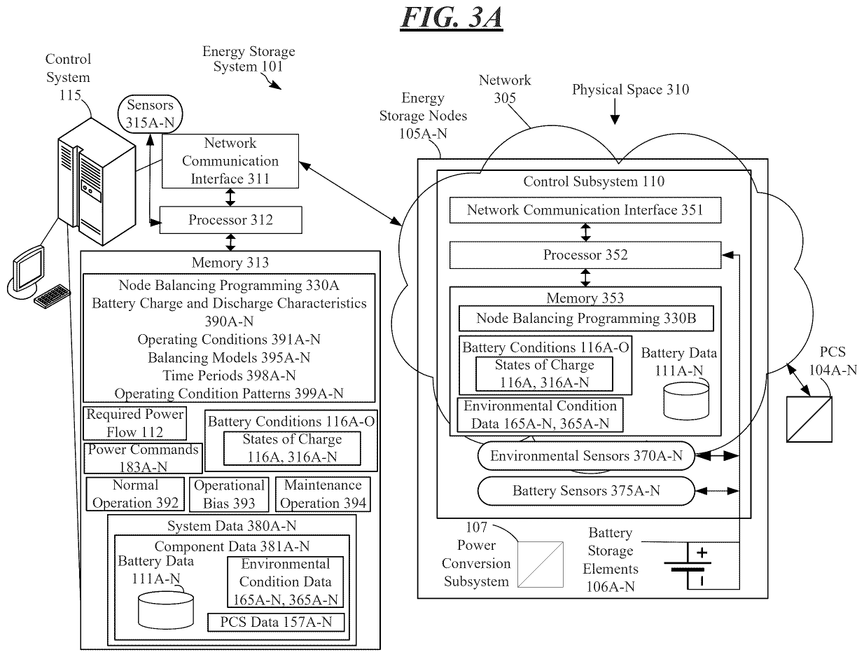

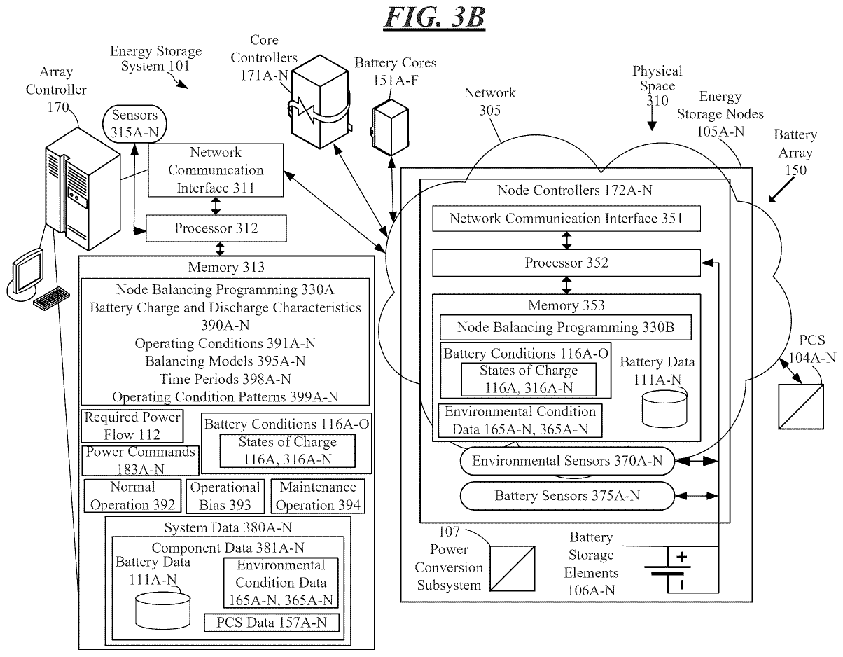

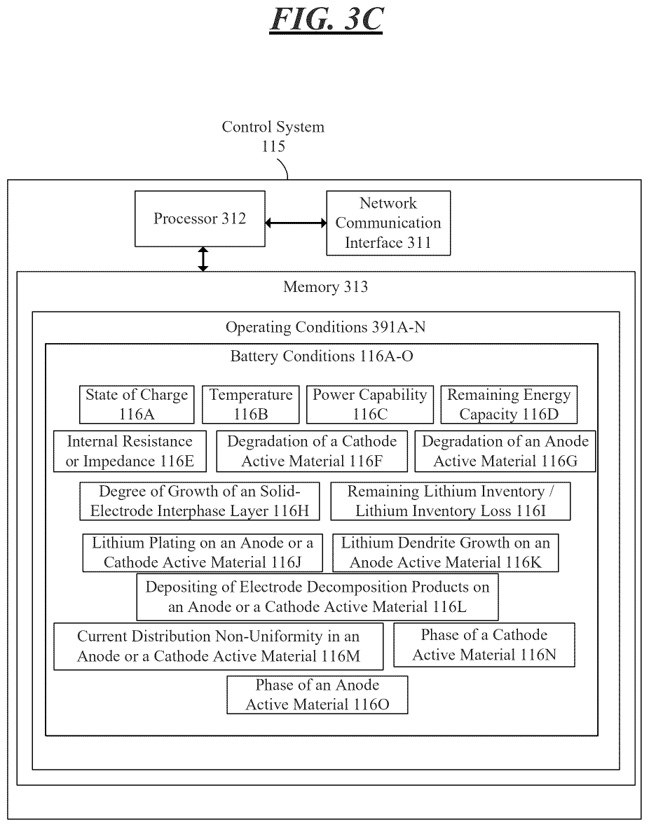

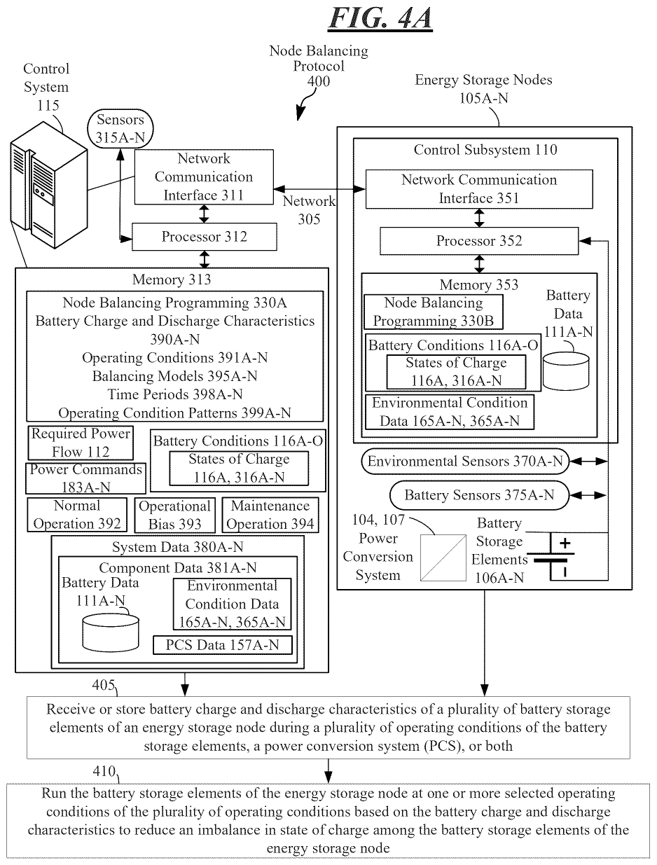

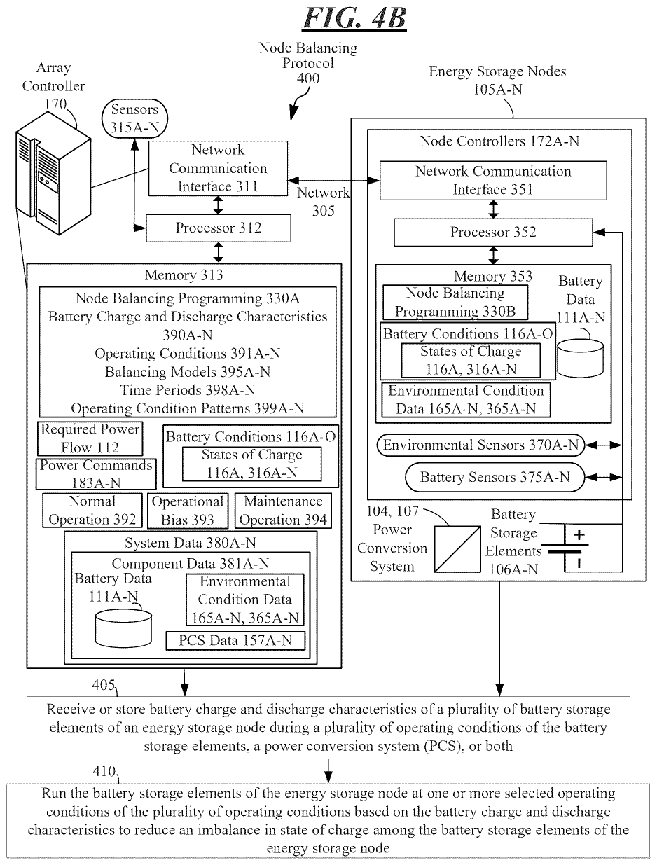

Control system 115 implements a node balancing protocol 400 (see FIGS. 4A-B) which can be implemented in node balancing programming 330A-B (see FIGS. 3A-B). The node balancing protocol 400 can reduce imbalance among the battery storage element 106A-N of a given energy storage node 105A. For example, the node balancing protocol 400 can utilize battery charge and discharge characteristics 390A-N that change during a plurality of operating conditions 391A-N, such as temperature, to improve balance as follows. When the control system 115 identifies a first subset of battery storage elements 106A-C of an energy storage node 105A as being at a different state of charge 116A than a second subset of battery storage elements 106D-F of the energy storage node 105A the battery storage elements 106A-N can be run at one or more selected operating conditions 391A of the plurality of operating conditions 391A-N. For example, the one or more selected operating conditions 391A can be a different temperature, changing electrical resistance, current carrying capability, range of state of charge 116A, C-rate, or other charging and discharging characteristics. The temperature can be a cell temperature, ambient temperature, internal air temperature, a coolant temperature, etc.

Operating conditions 391A-N can be observations of battery storage elements 106A-N or about different components, such as the PCS 104, bus bars, battery modules, or power cabling of the energy storage system 101 that can be targeted based on characteristics and a desired outcome. This results in differential performance as the energy storage system 101 operates. As a result, the first subset of battery storage elements 106A-C of the energy storage node 105A can achieve over time the same state of charge 116A as the second subset of battery storage elements 106D-F while still contributing to overall operation of the energy storage system 101.

As another example, it may be identified that running the energy storage system 101 in the one or more selected operating conditions 391A-N, such as a certain type or pattern of operation, tends to result in higher overall system balance (e.g., certain power profiles in certain ranges of state of charge 116A). The various energy storage nodes 105A-N or battery cores 151A-N in the energy storage system 101 can have an operational bias 393 to run in certain states of operation more frequently to gently nudge the energy storage system 101 back towards balance compared to other ways of achieving the same operational outcome. For example, the selected operation 391A can operate the PCS 104 based on PCS data 157A-N to influence balancing within an energy storage node 105A.

FIG. 1C depicts the array controller 170, the core controllers 171A-N, node controllers 172A-N, and enclosure controllers 173A-N in the example architecture of the control system 115 of FIGS. 1A-B. In the example, each of the energy storage nodes 105A-N can be a collection of one or more battery cubes 230A-N and every battery cube 230A-N includes an enclosure controller 173. A node controller 172 is the lowest controllable element of a battery core 151 for an energy storage node 105A-N and controls an individual energy storage node 105. A core controller 171 is the next higher level, which controls a subset of the energy storage nodes 105A-N, where each core represents branches of components of the energy storage system 101. The core controller 171 is a logical controller and can represent a transformer 108 that stands between the PCS 104 and the rest of the plant. Core controller 171 is an aggregator of different node controllers 172A-N and propagates power commands 183A-N from the array controller 170 to the node controllers 172A-N.

Array controller 170 is higher than the core controllers 171A-N and controls the overall energy storage system 101. The software for the array controller level can be installed at a customer installation site and can execute at the installation site, off-site, or a combination thereof. The array controller 170 can be a local decentralized service that runs onsite in real time.

A market dispatch unit controller 174 is a network wide controller and sits on top of the array controller 170 and looks at specific market requirements. The market dispatch unit controller 174 sets dispatch setpoints in terms of active and reactive power to the array controller 170 which deals with the energy storage system 101.

A battery core 151 can have multiple node controllers 172A-N depending on the number of energy storage nodes 105A-N and bus architecture of the battery core 151. In an example, if the PCS 104 is used as a single bus element, then there may be only one node controller 172 behind a core controller 171 for a single energy storage node 105A and only one PCS 104 per energy storage node 105A. But if the PCS 104 is used with multiple DC connections in a split bus architecture where a plurality of energy storage nodes 105A-D (e.g., four) are connected to the bus, there can be a plurality of energy storage nodes 105A-D on the bus and only one PCS 104 for all of the plurality of energy storage nodes 105A-D.

FIG. 1D depicts a power conversion system 104 of a battery core 151 of FIGS. 1A-C. As shown, the power conversion system 104 can include a power conversion unit 152, which can include a power inverter 205, rectifier 210, DC-DC converter 215, etc., or a combination thereof. The power conversion unit 152 can be an insulated-gate bipolar transistor (IGBT) module that is part of the PCS 104. The IGBT module can include an array of transistors (e.g., switching semiconductors), capacitors (e.g., filter capacitors), and any other power electronic devices to convert power. On one side of the power conversion unit 152 can be AC current and the other side DC current. The IGBT module is standard, but a variety of architectures can be used.

Power conversion system 104 further includes a heating, ventilation, and air conditioning (HVAC) equipment 153 to maintain the temperature of equipment of the PCS 104, such as the power conversion unit 152, within operating limits. The HVAC equipment 153 can include an air conditioner, such as a fan 154 and a condenser 155 to cool down the power conversion unit 152 (e.g., IGBT module). The HVAC equipment 153 can further include a heater 156.

The power conversion system 104 further includes a PCS controller 160 and environmental sensors 164A-N to protect the equipment of the PCS 104. Environmental sensors 164A-N, 370A-N can include water ingress sensors to detect water inside an enclosure of the PCS 104 or an enclosure 500 of a battery cube 230, gas sensors, particulate sensors, air sensors, or air pressure sensors. Infrared sensors can be used to detect temperature 165A, 375A such as heat inside enclosures of the PCS 104 or battery cube 230.

As shown, the PCS controller 160 includes a network communication interface 161, a processor 162, and a memory 163. The PCS 104 further includes PCS sensors 168A-N to measure a current 122 (e.g., a current magnitude) and a voltage 123 (e.g., DC link voltage). The environmental sensors 164A-N are coupled to the processor 163 and can collect environmental condition data 165A-N, for example, by measuring temperature 165A and humidity 165B inside of an enclosure of the PCS 104. The memory 163 can store the PCS data 157A-N, including the environmental condition data 165A-N collected by the environmental sensors 164A-N and the current 122 and the voltage 123 collected by PCS sensors 168A-N. The PCS data 157A-N, including the environmental condition data 165A-N, such as temperature 165A, current 122, and voltage 123 are monitored during the node balancing protocol 400 (see FIGS. 4A-B) and acted upon.

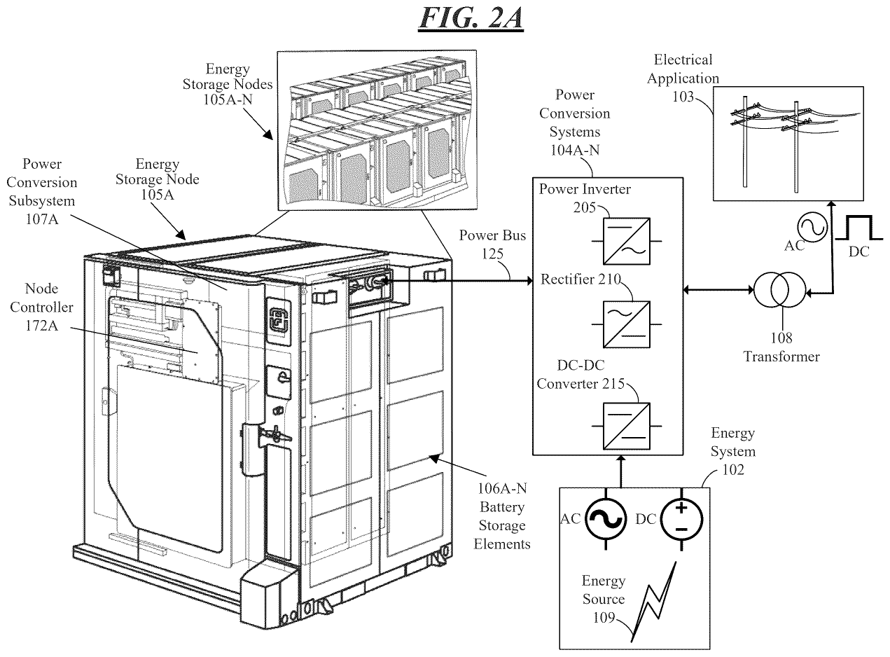

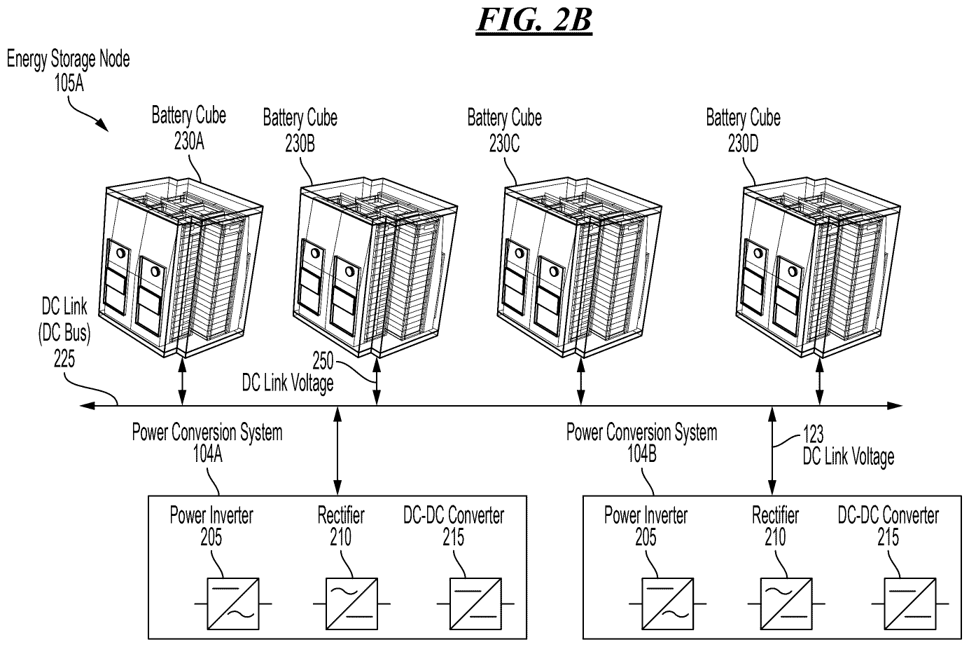

FIG. 2A illustrates a first energy storage node 105A of the plurality of energy storage nodes 105A-N of FIGS. 1A-C coupled to the electrical application 103. The first energy storage node 105A can include a single battery cube 230A (as in the case of FIG. 2A) or a plurality of battery cubes 230A-D (as in the case of FIG. 2B). Energy storage nodes 105A-N can include a battery storage element 106, a power conversion system 104 (or a power conversion subsystem 107), and a node controller 172 (or a control subsystem 110) to receive battery data 111A-N from the battery storage element 106, PCS data 157A-N from the power conversion system 104 (or the power conversion subsystem 107), or a combination thereof.

Power conversion system 104 (or the power conversion subsystem 107) can include a power inverter 205, a rectifier 210, a DC-DC converter 215, other power conversion elements, or a combination thereof. Power inverter 205 can be configured to convert a DC source, such as from the battery storage elements 106A-N, into an AC waveform. Rectifier 210 can be configured to convert an AC source, such as from the energy system 102 or electrical application 103, into DC for the battery storage elements 106A-N. DC-DC converter 215 can be configured to convert a DC source, such as from the battery storage elements 106A-N, into a different DC source characteristic.

If the energy source 109 is wind power, then the power conversion system 104 can convert the AC electricity produced into DC power for storage in the plurality of energy storage nodes 105A-N via the rectifier 210. If the energy source 109 is solar power, then the power conversion system 104 can convert the DC electricity into a different voltage level via the DC-DC converter 215. The power inverter 205 can convert the required power flow 112 from the energy storage system 101 from DC power into AC power during dispatch to the electrical application 103. For example, the power inverter 205 can be configured to convert power on a power bus 125 (e.g., AC bus, DC bus, or both) for use by the electrical application 103. For example, the power inverter 205 converts DC power stored in the energy storage nodes 105A-N into AC power for consumption by electrical loads of the electrical application 103.

Power conversion subsystem 107 includes similar hardware and software as the more centralized power conversion system 104. Power conversion subsystem 107 can be distributed more locally to each of energy storage nodes 105A-N. The node controller 172 and the control subsystem 110 can be configured for local computation, processing, and control of the battery storage elements 106A-N and the power conversion subsystem 107. The control system 115 and the array controller 170 can be configured for more centralized computation, processing, and controls of the overall energy storage system 101, energy system 102, electrical application 103, and power conversion system 104. The various controllers 170-173 of the control system 115, including the array controller 170, core controllers 171A-N, node controllers 172A-N, and enclosure controllers 173A-N can include a computing device, single board computer, an application-specific integrated circuit (ASIC), microcontroller, digital signal processor (DSP), field-programmable gate array (FPGA), or a combination thereof.

FIG. 2B illustrates a first energy storage node 105A that includes a plurality of battery cubes 230A-N and a plurality of power conversion systems 104A-N coupled to a DC link (DC bus) 225. As shown, the first energy storage node 105A includes four battery cubes 230A-D and two power conversion systems 104A-B coupled to the DC link (DC bus) 225 in the example. The first energy storage node 105A can be arranged so the battery cubes 230A-B are connected to a DC bus 225A with the PCS 104A in a split bus architecture. Battery cubes 230C-D can be connected to a DC bus 225B with the PCS 104B also in a split bus architecture. Battery sensors 375A-N can measure a DC link voltage 250 of the battery cube 230B on the DC bus 225A. PCS sensors 168A-N can measure a DC link voltage 123 of the PCS 104B on the DC bus 225B.

FIG. 3A is a high-level functional block diagram of the energy storage system 101 of FIG. 1A that depicts components of the control system 115 and the control subsystem 110 for node balancing of the energy storage system 101. FIG. 3B is another high-level functional block diagram of the energy storage system of FIGS. 1B-C that depicts components of the control system 115 with various controllers 170-173 for node balancing of the energy storage system 101.

Referring to FIGS. 3A-B, as shown, each of the plurality of energy storage nodes 105A-N can include a battery storage element 106A-N; a power conversion subsystem 107; and a control subsystem 110 (FIG. 3A) or a node controller 172 (FIG. 3B) to receive battery data 111A-N from the battery storage element 106A-N, PCS data 157A-N from the power conversion subsystem 107, or a combination thereof. The control system 115 can be coupled to the energy storage nodes 105A-N and PCS 104 and configured to receive battery data 111A-N from the battery storage element 106, PCS data 157A-N from the power conversion system 104 (or power conversion subsystem 107), or a combination thereof.

The control subsystem 110; control system 115, including the array controller 170, core controllers 171A-N, node controllers 172A-N, and enclosure controllers 173A-N; energy storage nodes 105A-N; electrical application 103; and other components of the system 100 can be in communication over a network 305 or one or more networks 305A-N. The networks 305A-N can be a local area network 305A, wide area network 305B, or a combination thereof. For example, the control system 115 can be coupled via a local area network 305A to the energy storage nodes 105A-N and the electrical application 103. Alternative or additionally, the control system 115 can be coupled via a wide area network 305B to the energy storage nodes 105A-N and electrical application 103. Or the control system 115 can be coupled via a combination of networks 305A-N, such as via a local area network 305A to components of the energy storage system 101, including the energy storage nodes 105A-N, and coupled via a wide area network 305B to the electrical application 103.

An example energy storage system 101 includes an energy storage node 105A. The energy storage node 105A includes a plurality of battery storage elements 106A-N, and a control subsystem 110 to receive battery data 111A-N from the battery storage elements 106A-N. The energy storage system 101 further includes a power conversion system (PCS) 104. Energy storage system 101 further includes a control system 115. The functionality of the control system 115 described herein, including the node balancing protocol 400 and node balancing programming 330A-B, can be divided across one or more computing devices that are coupled via a network 305. The node balancing protocol 400 can balance battery storage elements 106A-N, such as battery cells, of an energy storage node 105A without directly controlling the battery cells.

The control system 115 is coupled to the energy storage node 105A and the PCS 104. The control system 115, the control subsystem 110, or both are configured to receive or store battery charge and discharge characteristics 390A-N of the battery storage elements 106A-N during a plurality of operating conditions 391A-N of the battery storage elements 106A-N, the PCS 104, or both.

Battery charge and discharge characteristics 390A-N can store individual states of charge 316A-N of the battery storage elements 106A-N and the operating conditions 391A-N at which those states of charge 316A-N were observed. The battery charge and discharge characteristics 390A-N can be an SOC 116A range, a power level, temperatures, or any other operating parameters. An example battery charge and discharge characteristic 390A can be operating an energy storage node 105A at a higher power and higher temperatures near the top of the SOC range tends to create more imbalances in the battery storage elements 106A-N, such as battery cells. Battery charge and discharge characteristics 390A-N may indicate a given energy storage node 105A tends to be more balanced when running at a low power at a fraction of nominal power. The battery charge and discharge characteristics 390A-N can be based on power data from the PCS data 157A-N to have that insight and control the energy storage node 105A to influence the balance of that energy storage node 105A. The power data in the PCS data 157A-N can be collected from the PCS 104 on the AC side and DC side.

As discussed in further detail below, the node balancing programming 330A-B can apply balancing models 395A-N that include signal processing to determine the battery charge and discharge characteristics 390A-N, such as tendencies, trends, relationships, or correlations of when the energy storage system 101 is run in certain ways whether more or less imbalances within the energy storage node 105A occur. The signal processing builds up a history or library, such as a fingerprint, of what the imbalances look like over a variety of operating conditions 391A-N of the energy storage node 105A and then use that knowledge to select one or more selected operating conditions 391A in the future which result in lower levels of imbalance. The fingerprint of the energy storage node 105A can be created based on the signal processing so that an operational bias 393 can be applied to change the way the energy storage system 105 operates to take advantage of that information.

The control system 115, the control subsystem 110, or both are configured to run the battery storage elements 106A-N of the energy storage node 105A at one or more selected operating conditions 391A of the plurality of operating conditions 391A-N based on the battery charge and discharge characteristics 390A-N to reduce an imbalance in state of charge 116A among the battery storage elements 106A-N of the energy storage node 105A. For example, the dispatch of the energy storage node 105A can be controlled based on an operational bias 393 during a normal operation 392 to influence balancing or a separate maintenance operation 394 can be implemented. In some examples, the running the battery storage elements 106A-N at the one or more selected operating conditions 391A can be implemented as a communication of certain limits or preferences on the battery storage elements 106A-N instead of a direct dispatch.

The battery storage elements 106A-N, such as battery racks, can be made up of hundreds or thousands of individual battery cells. Even through the battery cells are not individually controllable, meaning the current flowing in and out of each battery cell is not separately controllable, each battery cell has an individual state of charge 316A-N. When all states of charge 316A-N are lined up with each other then the battery rack and energy storage node 105A-N are in balance. But when there is divergence there are varying states of charge 316A-N across battery cells that are making up the larger energy storage node 105A there can become issues with getting the most out of the energy storage node 105A and energy storage system 101.

For example, the PCS 104 can be operated at the one or more selected operating conditions 391A to rebalance the battery storage elements 106A-N (e.g. battery cells) even though the battery cells cannot be controlled individually. The node balancing programming 330A-B can balance on the battery cell level of a particular cube 230A of the energy storage node 105A based on the one or more selected operating conditions 391A based on the following relationships. The battery cells are connected together in a battery module, the battery module is connected together in a battery rack, and the battery rack is connected to a battery cube 230, and the battery cube 230 to the energy storage node 105. Each of these levels can be balanced by controlling the PCS 104 at the one or more selected operating conditions 391A.

The control system 115, the control subsystem 110, or both can be configured to determine states of charge 316A-N of each of the battery storage elements 106A-N of the energy storage node 105A from the battery data 111A-N during the one or more selected operating conditions 391A. The control system 115, the control subsystem 115, or both can be configured to identify a first subset of battery storage elements 106A-C at a different state of charge than a second subset of battery storage elements 106D-F based on the determined states of charge 316A-N.

When the battery storage elements 106A-N are battery cells, it is not possible to run the first subset of battery storage elements 106A-C and the second set of battery storage elements 106D-F separate from each other. Rather, the goal is to run all of the battery storage elements 106-N at the one or more selected operating conditions 391A in such a way to reduce the difference in states of charge 316A-N across the battery storage elements 106A-N. Reducing the imbalance in state of charge 116A among the battery storage elements 106A-N can lower the mismatch, including but not limited to minimizing the differences in states of charge 316A-N. In addition to controlling the required power flow 112, the control system 115, control subsystem 110, or both can impose limits on state of charge 116A, instruct battery modules to run at higher or lower temperatures, etc. which can in sum make up the one or more selected operating conditions 391A.

In a first example, the running the battery storage elements 106A-N of the energy storage node 105A at one or more selected operating conditions 391A includes dispatching a required power flow 112 across the first subset of battery storage elements 106A-C and the second subset of battery storage elements 106D-F of the energy storage node 105A at the one or more selected operating conditions 391A during a normal operation 392 to reduce a mismatch in the states of charge 316A-N between the first subset of battery storage elements 106A-C and the second subset of battery storage elements 106D-F. The one or more selected operating conditions 391A can include an operational bias 393 during the normal operation 392.

For example, a first battery storage element 106B, such as a first battery cell, with the highest state of charge 316A and a fourth battery storage element 106D, such as a fourth battery cell, with the lowest state of charge 316D within the first energy storage node 105A can have a gap in state of charge 116A of 10%. Although the first battery storage element 106A and the fourth battery storage element 106D are battery cells in the example and therefore not individually controllable, the node balancing programming 330A-B can apply an operational bias 393 to the way the energy storage system 101 operates to bring that imbalance down. The operational bias 393 can operate the battery storage elements 106A-N in a different way to influence balancing behavior compared to a normal operation 392.

Operational bias 393 is not limited to operational changes, but can be an operational adjustment or an operation during a normal operation 392 to dispatch a required power flow 112, such as minor and major changes to the normal operation 392. The operational bias 393 can include running the battery storage elements 106A-N in a particular way, such as varying a temperature, current carrying capability, etc. The operational bias 393 can be a small deviation to the normal operation 392 during a primary operation of the energy storage system 101. The normal operation 392 can be when the energy storage system 101 is putting energy on and off the electrical application 103.

The maintenance operation 394 can be a wholly separate operational dispatch, such as a discrete function, not for the purpose of dispatching a required power flow 112. The maintenance operation 394 can occur separately for dedicated purposes of balancing battery cells to place the energy storage system 101 in a better balance of state of charge 116A, 316A-N. For the example, the maintenance operation 394 can be a separate function, such as to deplete zinc batteries. The difference between normal operation 392 and the maintenance operation 394 can be whether balancing the states of charge 316A-N of the battery storage elements 106A-N is being performed while performing the primary function of the energy storage system 101 or as a discrete function which is balancing.

In a second example, the running the battery storage elements 106A-N of the energy storage node 105A at the one or more selected operating conditions 391A includes charging or discharging the first subset of battery storage elements 106A-C and the second subset of battery storage elements 106D-F of the energy storage node 105A at the one or more selected operating conditions 391A during a maintenance operation 394 to reduce a mismatch in the states of charge 316A-N between the first subset of battery storage elements 106A-C and the second subset of battery storage elements 106D-F.

The node balancing programming 330A-B can take advantage of the phenomena between battery cells which are not addressable by utilizing the addressable control subunit, such as an energy storage node 105A, battery cube 230, battery rack, or battery module. Regardless of the addressable control subunit, the one or more selected operating conditions 391A can apply an operational bias 393 to address a battery cell to cell imbalance difference. The operational bias 393 can be based on the insight that the degree of imbalance in the battery storage elements 106A-N changes based on selected operating conditions 391A-N as to how the energy storage system 101 is operated. For example, a selected operating condition 391A can be a certain temperature region that can make the balance of the battery storage elements 106A-N better. Another selected operating condition 391B can be an electrical resistance that makes up components of the energy storage system 101 and choosing to operate the components with different electrical resistances to improve an amount of balance of the battery storage elements 106A-N. These selected operating conditions 391A-B can be applied as an operational bias 393 that is introduced during a normal operation 392 to intentionally bring the energy storage node 105A into an operational state where balances will be reduced, for example, minimized.

The one or more selected operating conditions 391A can include a temperature, an electrical resistance, a current rate (C-rate), a current carrying capability, an eddy current, a conductance, a power pulse pattern during charging or discharging, other charging and discharging characteristics, battery storage element characteristics, impedance of AC and DC components, other electrical characteristics, or a power command 183A-N from the PCS 104.

The node balancing protocol 400 may balance the energy storage system 101 regardless of the states of charge 316A-N of the battery storage elements 106A-N. In other words, the node balancing protocol 400 does not need to determine different states of charge 316A-N and can instead chose not to observe and just operate to reduce imbalance. There are actions that can be taken with the PCS 104 to place the energy storage node 105A in a state of charge 316A that is more balanced by issuing different power commands 183A-B, not issuing certain power commands 183C-D, and adjusting rates. The PCS 104 can operate to continuously reduce imbalance in the battery storage elements 106A-N and not observe actual imbalances via a determined states of charge 316A-N step and then take action by running the battery storage elements 106A-N at the one or more selected operating conditions 391A.

The running the battery storage elements 106A-N of the energy storage node 105A at the one or more selected operating conditions 391A of the plurality of operating conditions 391A-N based on the battery charge and discharge characteristics 390A-N to reduce the imbalance in state of charge 116A among the battery storage elements 106A-N of the energy storage node 105A can include the following. First, selecting the one or more selected operating conditions 391A of the plurality of operating conditions 391A-N based on the battery charge and discharge characteristics 390A-N to reduce the imbalance in the state of charge 116A among the battery storage elements 106A-N of the energy storage node 105A. Second, running the battery storage elements 106A-N of the energy storage node at the one or more selected operating conditions 391A.

The selecting the one or more selected operating conditions 391A of the plurality of operating conditions 391A-N based on the battery charge and discharge characteristics 390A-N to reduce the imbalance in the state of charge 116A among the battery storage elements 106A-N of the energy storage node 105A can include the following. First, applying one or more balancing models 395A-N to the battery charge and discharge characteristics 390A-N and the determined states of charge 316A-N over one or more time periods 398A-N. Second, selecting the one or more selected operating conditions 391A based on the applied one or more balancing models 395A-N

Imbalances exist within the battery storage elements 106A-N, such as battery cells, of the energy storage node 105A for a variety of reasons. For example, imbalances can exist because the battery cells have different characteristics (e.g., an uneven temperature profile); the buses 125, 225 can have different characteristics; or other sources of non-uniformity within the energy storage node 105A. In order to minimize the non-uniformity, balancing models 395A-N can characterize relationships between all of the variables via the battery charge and discharge characteristics 390A-N and the plurality of operating conditions 391A-N to analyze what imbalances can develop.

The applying one or more balancing models 395A-N to the battery charge and discharge characteristics 390A-N and the determined states of charge 316A-N over the one or more time periods 398A-N can include the following. First, feeding the states of charge 316A-N into one or more balancing models 395A-N. Second, holding the states of charge 316A-N over the one or more time periods 398A-N. Third, matching the states of charge 316A-N over the more time periods 398A-N against operating condition patterns 399A-N previously identified as being associated with reducing the imbalance in the determined states of charge 316A-N.

Balancing models 395A-N may determine to operate the energy storage node 105A in a manner that prevents imbalances from developing. The balancing models 395A-N are a combination of: (1) receiving and storing the battery charge and discharge characteristics 390A-N during the plurality of operating conditions 391A-N; and (2) then making determinations of the one or more selected operating conditions 391A that reduce imbalance at those battery charge and discharge characteristics 390A-N. Balancing models 395A-N can be based on physical modeling of the energy storage system 101, for example a model describing the electrical and thermal properties of the components or a machine learning model, for example a neural network which infers relationships between operational parameters and misbalancing behavior.

For example, misbalancing can be determined based on the state of charge 116A at the peak of charge and the state of charge 116A at the peak of discharge. However, determining a solution for misbalancing may require examining the temperature 165A, 365A over one or more time periods 398A-N of the components and sub-components; the electrical draw both requested and provided over the time periods 398A-N of the components and sub-components; the physical distance between vertically-connected components (e.g., the distance between energy storage node 105A and PCS 104); or the resistivity or current carrying capacity of interconnecting components of the energy storage system 101 in some examples. Balancing models 395A-N may also review battery storage elements 106A-C which have remained balanced while their peer battery storage elements 106D-F have become misbalanced, in order to improve understanding of cause-and-effect relationships, and overall solutioning to misbalancing.

Balancing models 395A-N may be a machine learning or an artificial intelligence model, and may be a model which utilizes regression analysis and Markov chains to make associations between seemingly disparate raw data points in order to better understand cause-and-effect relationships. Such balancing models 395A-N may constitute or utilize a convolutional neural net, where the physical mechanism between the input and output is not fully understood. For example, balancing models 395A-N may ascertain, or may be programmed to know, that battery charge and discharge characteristics 390A-N change with temperature 165A, 365A. And that the change in battery charge and discharge characteristics 390A-N may not be linear with respect to time; temperature 165A, 365A; or state of charge 116, 316A-N; or rate of state of charge change.

The balancing models 395A-N may include a physical model of the energy storage system 101 that predicts the degree to which balance is affected. For example, by altering the relative temperatures between the battery racks. Balancing models 395A-N can be fed multivariate inputs from the node balancing programming 330A-B. The balancing models 395A-N can decide the one or more selected operating conditions 391A that will have the greatest impact on reducing imbalance amongst the battery storage elements 106A-N. For example, running the battery storage elements 106A-N at a certain power profile or higher operating temperature can change the electrical resistance, current carrying capability, or other charging and discharging characteristics to bring the battery storage elements 106A-N in better aligned states of charge 316A-N.

Balancing models 395A-N can take inputs, such as states of charge, 116A, 316A-N and various system data 380A-N, and be designed to balance the energy storage node 105A through a set of known or learned heuristics. The balancing models 395A-N may not have any inputs from the current energy storage node 105A but can have heuristics based on being trained on other commonly operated energy storage systems. The balancing models 395A-N can select the one or more selected operating conditions 391A including a lower C-rate, a higher C-rate, spending more time towards a top of charge, spending more time towards a bottom of charge, using a narrower depth of discharge, using a broader depth of discharge, pause, pulse, pulse positively, pulse negatively, pulse only positively, pulse only negatively, etc.

Control system 115 of FIG. 3A and array controller 170 of FIG. 3B include a network communication interface 311 configured for wired or wireless communication over the network 305. The control system 115 and the array controller 170 further include a memory 313, and a processor 312 coupled to the network communication interface 311 and the memory 313. As shown, the memory 313 of the control system 115 and the array controller 170 is configured to store node balancing programming 330A; battery charge and discharge characteristics 390A-N; operating conditions 391A-N, balancing models 395A-N; time periods 398A-N, and operating condition patterns 399A-N. The memory 313 of the control system 115 and the array controller 170 is further configured to store a required power flow 112; battery conditions 116A-O (including a state of charge 116A); power commands 183A-N; a normal operation 392; an operational bias 393, a maintenance operation 394; and system data 380A-N, including component data 381A-N, such as battery data 111A-N, environmental condition data 365A-N from the energy storage nodes 105A-N, and PCS data 157A-N (including the environmental condition data 165A-N from the PCSs 104A-N). The control system 115 and the array controller 170 can also include sensors 315A-N coupled to the processor 312 to detect or monitor various system parameters, such as power, temperature, voltage, current, resistance, and/or impedance. For example, the sensors 315A-N, battery sensors 375A-N can be coupled to the power bus 125 and the DC link (DC bus) 225.

Control system 115 and the array controller 170 can be configured to receive or store a required power flow 112 or a power capacity for an electrical application 103 and to dispatch the required power flow 112 across the plurality of energy storage nodes 105A-N. The required power flow 112 can include an active power (e.g., measured in kW or mW), a reactive power (e.g., measured in kVARs), or a total system power discharge or charge requirement. The required power flow 112 can be a power command 183 for the electrical application 103 based on a customer or independent system operator request received over the network 305 from the electrical application 103, in which case the power command 183 is externally determined. The power capacity can be apparent power (e.g., kVA or MVA), such as name plate capacity measured in volt-amperes that can be used for power electronics or electronic equipment to define capabilities in terms of overall power. Both active power and reactive power come together to form apparent power and manufacturers define the capability of the power capacity of power electronics equipment based on the apparent power.

The power command 183 for the electrical application 103 can be based on parameters in a customer or independent system operator request received over the network 305 from the electrical application 103. For example, the parameters can be to provide frequency regulation with a deadband and a slope of the response. The control system 115 can take the parameters and attempt to determine the power command 183, for example, based on satisfying the customer or independent system operator request for the electrical application 103.

Control system 115 can take the required power flow 112 needed for the electrical application 103, for example, as requested by a customer or software application and determine the optimal way to distribute the required power flow 112 across all of the energy storage nodes 105A-N. This optimization may be conducted in several manners, for example using traditional operational optimization techniques or machine-learning based techniques. The control system 115 can include one or more processors, controllers, or computing devices that can be configured to perform closed loop management of real and reactive power supplied to the electrical application 103.

Energy storage nodes 105A-N include a control subsystem 110 in FIG. 3A and a node controller 172 in FIG. 3B, battery storage elements 106A-N, and a power conversion subsystem 107 (or a power conversion system 104), which can reside on each individual energy storage node 105A-N. The control subsystem 110 and the node controller 172 of the energy storage nodes 105A-N include a network communication interface 351 configured for wired or wireless communication over the network 305. The control subsystem 110 and the node controller 172 further include a memory 353, and a processor 352 coupled to the network communication interface 351 and the memory 353. As shown, the memory 353 of the control subsystem 110 and the node controller 172 is configured to store node balancing programming 330B, battery data 111A-N, battery conditions 116A-O (including a state of charge 116A), and environmental condition data 165A-N, 365A-N.

The control subsystem 110 and the node controller 172 further include environmental sensors 370A-N and battery sensors 375A-N coupled to the processor 352. Environmental sensors 370A-N can collect environmental condition data 365A-N, for example, by measuring humidity and temperature inside of an enclosure 500 of the energy storage nodes 105A-N, such as one or more battery cubes 230A-N. Battery sensors 375A-N can include a voltage sensor 375A, a current sensor 375B, and a temperature sensor 375C to measure readings of battery data 111A-N, such as a voltage 111A, a current 111B, a temperature 111C, or other physical phenomena occurring within the battery storage elements 106A-N. The memory 353 can store the environmental condition data 365A-N collected by the environmental sensors 370A-N and the battery data 111A-N measured by the battery sensors 375A-N.

The control subsystem 110 or the control system 115 is configured to determine at least one battery condition 116A-O, 316A-N about one or more of the energy storage nodes 105A-N from the battery data 111A-N. The battery conditions 116A-O, 316A-N can be algorithmically determined estimates from battery data 111A-N, readings from the sensors 315A-N, battery sensors 375A-N that monitor various system parameters on the power bus 125, DC link (DC bus) 225, or a combination thereof, for example. State estimating algorithms can take the measured readings of battery data 111A-N, including the voltage 111A, the current 111B, the temperature 111C, or a combination thereof as input parameters and estimate the battery conditions 116A-O, 316A-N based on the battery data 111A-N.

For example, a state of charge 116A, 316A-N is a state estimate derived from the voltage 111A and the current 111B readings. The state of charge 116A, 316A-N can be derived from the control system 115. Alternatively or additionally, at least one battery management system (BMS) or the node controller 172 can derive the state of charge 116A, 316A-N. The state of charge 116A, 316A-N can be determined at a variety of levels. In a first example, the state of charge 116A, 316A-N can be determined at the battery storage element level 106, such as for individual battery storage elements 106A-N (e.g., battery racks, battery modules, and battery cells). In a second example, the state of charge 116A, 316A-N can be determined at the battery cube level, such as for individual battery cubes 230A-N. In a third example, the state of charge 116A, 316A-N can be determined at the energy storage node level, such as for a first energy storage node 105A that includes a plurality of battery cubes 230A-N.

The control subsystem 110 can include at least one battery management system (BMS) to determine the state of charge 116A, 316A-N. The SOC 116A, 316A-N provided by a battery management system, for example, can be based on Coulombe counting and be a number from 0-100% as to whether a battery storage element 106A-N, such as a battery cell, is full or empty. The SOC 116A, 316A-N can be provided at the battery cell level for all of the battery cubes 230A-N on that DC bus 225. Each battery rack of a battery cube 230 can have a BMS and that information can be propagated for each individual battery cell to a system level BMS to determine the SOC 116A, 316A-N of each battery storage element 106A-N, such as each individual battery rack, battery module, or battery cell in the battery cube 230 of the energy storage node 105A.

SOC calculations may look at voltage on the DC bus 225 over time. In some examples, the SOC 116A, 316A-N can be determined for an entire energy storage node 105A-N (e.g., a first energy storage node 105A including all seven battery cubes 230A-G of all battery storage elements 106A-N behind the first energy storage node 105A). For example, the SOC 116A, 316A-N can be a calculated number of all battery cubes 230A-G put together on that first energy storage node 105A based on how much current is being put through and how much energy can get out. The SOC 116A, 316A-N can be one parameter reading for an entire DC bus 225 for the first energy storage node 105A.

Some state estimating algorithms may receive measured readings from the battery sensors 375A-N of the control subsystem 110 and sensors 315A-N of the control system 115 to derive other parameters, such as real time power. For example, real time power may be derived as a parameter in order to determine the battery conditions 116A-O.

The control system 115 and the array controller 170 can manage power commands 183A-N to the control subsystem 110 and the node controller 172 respectively, to charge or discharge the plurality of energy storage nodes 105A-N based on the required power flow 112. For example, the control system 115 and the array controller 170 can send the power commands 183A-N based on the total required power flow 112 to the plurality of energy storage nodes 105A-N. Alternatively or additionally, the control subsystem 110 and the node controller 172 can issue the power commands 183A-N directly at the plurality of energy storage nodes 105A-N based on the required power flow 112.

FIG. 3C is a block diagram of the control system 115 depicting various types of battery conditions 116A-O to implement the node balancing protocol 400 of FIGS. 4A-B. As shown, the operating conditions 391A-N can include battery conditions 116A-O. The battery conditions 116A-O can include: a state of charge 116A, a temperature 116B, a power capability 116C, remaining energy capacity 116D, an internal resistance or impedance 116E, a degradation of a cathode active material 116F, a degradation of an anode active material 116G, a degree of growth of a solid-electrode interphase (SEI) layer 116H, remaining lithium inventory/lithium inventory loss 116I, lithium plating on an anode or a cathode active material 116J, a lithium dendrite growth on an anode active material 116K, depositing of electrode decomposition products on an anode or a cathode active material 116L, a current distribution non-uniformity in an anode or a cathode active material 116M, a phase of a cathode active material 116N, a phase of an anode active material 116O, or a combination thereof.

The battery conditions 116A-O can be determined by applying power pulse patterns during charging or can discharging cycles that include a higher frequency charge or discharge swing. In an example, the power pulse pattern during battery charging can include to charge to a first voltage for a first period of time, stop charging for a second period of time, then charge to a second voltage for a third period of time, stop charging for a fourth period of time, and then charge to a third voltage for a fifth period of time. The power pulse pattern during battery discharging can include to discharge to a first voltage for a first period of time, stop discharging for a second period of time, then discharge to a second voltage for a third period of time, stop discharging for a fourth period of time, and then discharge to a third voltage for a fifth period of time. The voltages and timing (e.g., periods of time) of the power pulse patterns 118B-C can be adjusted during the charging and discharging cycles to provide a set of battery data 111A-N to feed the state estimating algorithms in order to determine the battery conditions 116A-O.

FIG. 4A is a node balancing protocol 400 for the energy storage system 101 of FIG. 1A that is implemented by the control system 115, the control subsystem 110, and the plurality of energy storage nodes 105A-N. In the example of FIG. 4A, the node balancing protocol 400 can be implemented in the node balancing programming 330A of the control system 115, the node balancing programming 330B of the control subsystem 110, or both. Alternatively or additionally, node balancing programming 330C can reside on the PCS 104.

FIG. 4B is the node balancing protocol 400 for the energy storage system 101 of FIGS. 1B-C that is implemented by the various controllers 170-173 of the control system 115, and the plurality of energy storage nodes 105A-N. In the example of FIG. 4B, the node balancing protocol 400 can be implemented in the node balancing programming 330A of the array controller 170, the node balancing programming 330B of the node controller 172, or both.

Although there can be imbalances among the plurality of energy storage nodes 105A-N, such as between the state of charge 116A of a first energy storage node 105A and a second energy storage node 105B, the node balancing protocol 400 can resolve imbalances within the battery storage elements 106A-N of the first energy storage node 105A itself. For example, the node balancing protocol 400 balances states of charge 316A-N at the lower level of the battery storage elements 106-N, such as a battery rack, battery module, and battery cell which are enclosed within a battery cube 230. In other words, the node balancing protocol 400 can balance within the first energy storage node 105A at the level of non-addressable units, such as battery cells.

Referring to both FIGS. 4A-B, execution of node balancing programming 330A stored in a memory 313 by a processor 312 of the control system 115 (e.g., array controller 170) configures the control system 115 (e.g., array controller 170) to implement blocks 405 and 410 described below. Execution of node balancing programming 330B stored in a memory 353 by a processor 352 of the control subsystem 110 (e.g., node controller 172) can configure the control subsystem 110 (e.g., node controller 172) to implement some portion or all of blocks 405 and 410 described below. More generally, the execution of the node balancing programming 330A-B by one or more processors 312, 352 can configure one or more controllers 110, 115, 170-173 to implement blocks 405 and 410 below.

Beginning in block 405, the node balancing protocol 400 includes to receive or store battery charge and discharge characteristics 390A-N of a plurality of battery storage elements 106A-N of an energy storage node 105A during a plurality of operating conditions 391A-N of the battery storage elements 106A-N, a power conversion system (PCS) 104, or both.

Moving now to block 410, the node balancing protocol 400 further includes to run the battery storage elements 106A-N of the energy storage node 105A at one or more selected operating conditions 391A of the plurality of operating conditions 391A-N based on the battery charge and discharge characteristics 390A-N to reduce an imbalance in state of charge 116A among the battery storage elements 106A-N of the energy storage node 105A.

The node balancing protocol 400 can further include to determine states of charge 316A-N of each of the battery storage elements 106A-N of the energy storage node 105A from battery data 111A-N during the one or more selected operating conditions 391A. The node balancing protocol can further include to identify a first subset of battery storage elements 106A-C at a different state of charge than a second subset of battery storage elements 106D-F based on the determined states of charge 316A-N.

In an example of block 410, the running the battery storage elements 106A-N of the energy storage node 105A at the one or more selected operating conditions 391A includes dispatching a required power flow 112 across the first subset of battery storage elements 106A-C and the second subset of battery storage elements 106D-F of the energy storage node 105A at the one or more selected operating conditions 391A during a normal operation 392 to reduce a mismatch in the states of charge 316A-N between the first subset of battery storage elements 106A-C and the second subset of battery storage elements 106D-F. The one or more selected operating conditions 391A include an operational bias 393 during the normal operation 392.

In FIG. 4B, the core controllers 171A-N, node controllers 172A-N, and enclosure controllers 173A-N can implement a subset or all of the blocks 405 and 410 of the node balancing protocol 400 without the central array controller 170. In some examples, the functionality of the array controller 170 and the node balancing programming 330A-B can be separated into one or more controllers or computing devices. The node balancing programming 330A-B may be stored and executed on the one or more controllers or computing devices.

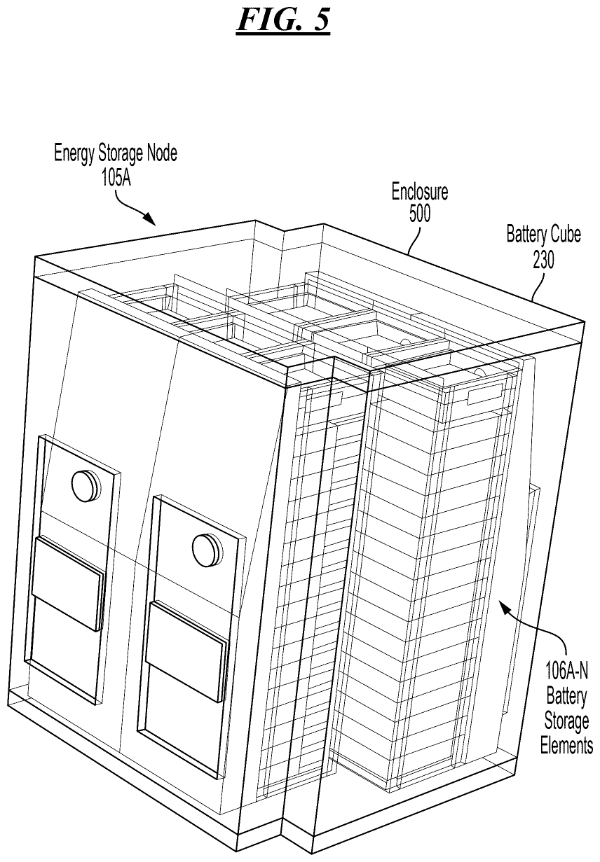

FIG. 5 is a cutaway view of the first energy storage node 105A of the plurality of energy storage nodes 105A-N and shows details of a plurality of battery storage elements 106A-N. As shown, the energy storage node 105A includes an enclosure 500, such as a physical housing to store a plurality of battery storage elements 106A-N. The battery storage elements 106A-N can be a collection of one or more batteries, such as a plurality of battery strings or battery banks, which are organized logically, physically, and electrically.

In the example of FIG. 5, the battery storage elements 106A-N can include battery racks (e.g., six are shown) that hold a respective stack of battery modules (e.g., seventeen are shown). The battery modules can include an array of prismatic, pouch, or cylindrical battery cells that are packaged together to increase voltage, amperage, or both. In some examples, battery modules may include an electric vehicle battery pack, e.g., a collection of lithium-ion battery cells that are packaged together.

Each of the energy storage nodes 105A-N can include a collection of one or more enclosures 500A-N like that shown in FIG. 5 that house a plurality of battery storage elements 106A-N packaged together as a battery cube 230 in the example. Of course, the enclosure 500 can be shaped in a variety of other form factors. Each of the battery cubes 230A-N can further include a respective enclosure controller 173A-N that is controlled by a respective node controller l72A-N as part of the control system 115.

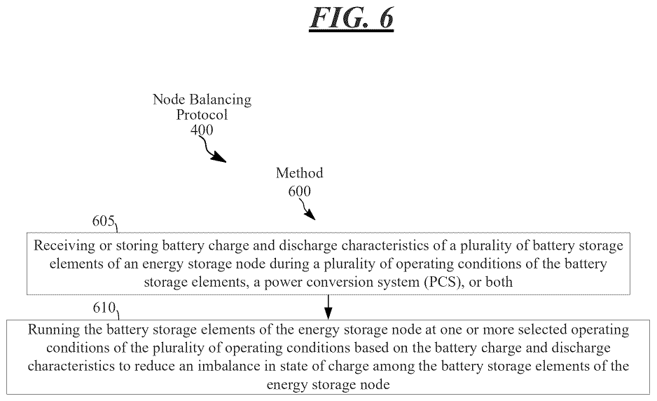

FIG. 6 is a flowchart of a method 600 that can be implemented for node balancing of the energy storage system 100. In the example of FIG. 6, the method 600 implements the node balancing protocol 400 of FIG. 4. Beginning in step 605, the method 600 includes receiving or storing battery charge and discharge characteristics 390A-N of a plurality of battery storage elements 106A-N of an energy storage node 105A during a plurality of operating conditions 391A-N of the battery storage elements 106A-N, a power conversion system (PCS) 104, or both.

Continuing to step 610, the method 600 further includes running the battery storage elements 106A-N of the energy storage node 105A at one or more selected operating conditions 391A of the plurality of operating conditions 391A-N based on the battery charge and discharge characteristics 390A-N to reduce an imbalance in state of charge 116A among the battery storage elements 106A-N of the energy storage node 105A.

The method 600 can further include determining states of charge 316A-N of each of the battery storage elements 106A-N of the energy storage node 105A from battery data 111A-N during the one or more selected operating conditions 391A. The method 600 can further include identifying a first subset of battery storage elements 106A-C at a different state of charge than a second subset of battery storage elements 106D-F based on the determined states of charge 316A-N.

In an example of step 610, the running the battery storage elements 106A-N of the energy storage node 105A at the one or more selected operating conditions 391A includes dispatching a required power flow 112 across the first subset of battery storage elements 106A-C and the second subset of battery storage elements 106D-F of the energy storage node 105A at the one or more selected operating conditions 391A during a normal operation 392 to reduce a mismatch in the states of charge 316A-N between the first subset of battery storage elements 106A-C and the second subset of battery storage elements 106D-F. The one or more selected operating conditions 391A include an operational bias 393 during the normal operation 392. Reducing the imbalance can limit the degree of difference in state of charge 316A-N between battery storage elements 106A-N.

In the examples above, the energy system 102, energy application 103, power conversion system 104, energy storage nodes 105A-N, control subsystem 110, control system 115, array controller 170, core controllers 171A-N, node controllers 172A-N, enclosure controllers 173A-N, etc. each include a network communication interface 161, 311, 351 for wired or wireless communication over one or more networks 305A-N. The networks 305A-N interconnect the links to/from the network communication interfaces 161, 311, 351 of the devices, so as to provide data communications amongst the energy application 103, energy storage nodes 105A-N, control system 115, array controller 170, core controllers 171A-N, node controllers 172A-N, enclosure controllers 173A-N, etc. Networks 305A-N may support data communication by equipment at the premises via wired (e.g., cable or fiber) media or via wireless (e.g., Wi-Fi, Bluetooth™, ZigBee, LiFi, IrDA, etc.) or combinations of wired and wireless technology.

Any of the functionality of the node balancing protocol 400, including node balancing programming 330A-B, described herein for the energy system 102, electrical application 103, power conversion system 104, energy storage nodes 105A-N, control subsystem 110, control system 115, array controller 170, core controllers 171A-N, node controllers 172A-N, enclosure controllers 173A-N, etc. can be embodied in one or more applications or firmware as described previously. According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++) or procedural programming languages (e.g., C or assembly language).

In the examples above, the energy system 102, energy application 103, power conversion system 104, energy storage nodes 105A-N, control subsystem 110, control system 115, array controller 170, core controllers 171A-N, node controllers 172A-N, enclosure controllers 173A-N, etc. can each include a processor. As used herein, a processor 162, 312, 352 is a hardware circuit having elements structured and arranged to perform one or more processing functions, typically various data processing functions. Although discrete logic components could be used, the examples utilize components forming a programmable central processing unit (CPU). A processor 162, 312, 352 for example includes or is part of one or more integrated circuit (IC) chips incorporating the electronic elements to perform the functions of the CPU. The processors 162, 312, 352 for example, may be based on any known or available microprocessor architecture, such as a Reduced Instruction Set Computing (RISC) using an ARM architecture. Of course, other processor circuitry may be used to form the CPU or processor hardware in. The illustrated examples of the processors 162, 312, 352 can include one microprocessor or a multi-processor architecture. A digital signal processor (DSP) or field-programmable gate array (FPGA) could be suitable replacements for the processors 162, 312, 352, but may consume more power with added complexity.

The applicable processor 162, 312, 352 executes programming or instructions to configure the energy system 102, energy application 103, power conversion system 104, energy storage nodes 105A-N, control subsystem 110, control system 115, array controller 170, core controllers 171A-N, node controllers 172A-N, enclosure controllers 173A-N, etc. to perform various operations. For example, such operations may include various general operations (e.g., a clock function, recording and logging operational status and/or failure information) as well as various system-specific operations (e.g., energy management) functions. Although a processor 162, 312, 352 may be configured by use of hardwired logic, typical processors are general processing circuits configured by execution of programming, e.g., instructions and any associated setting data from the memories 163, 313, 353 shown or from other included storage media and/or received from remote storage media.

In the examples above, the energy system 102, energy application 103, power conversion system 104, energy storage nodes 105A-N, control subsystem 110, control system 115, array controller 170, core controllers 171A-N, node controllers 172A-N, enclosure controllers 173A-N, etc. each include a memory. The memory 163, 313, 353 may include a flash memory (non-volatile or persistent storage), a read-only memory (ROM), and a random access memory (RAM) (volatile storage). The RAM serves as short term storage for instructions and data being handled by the processors 162, 312, 352 e.g., as a working data processing memory. The flash memory typically provides longer term storage.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

Hence, a machine-readable medium or a computer-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

According to exemplary embodiments of the present disclosure the one or more processors and control circuits can include one or more of any known general purpose processor or integrated circuit such as a central processing unit (CPU), microprocessor, field programmable gate array (FPGA), Application Specific Integrated Circuit (ASIC), Digital Signal Processor (DSP), or other suitable programmable processing or computing device or circuit as desired that is specially programmed to perform operations for achieving the results of the exemplar embodiments described herein. The processor(s) can be configured to include and perform features of the exemplary embodiments of the present disclosure, such as the node balancing protocol 400 and the node balancing programming 330A-B. The features can be performed through program code encoded or recorded on the processor(s), or stored in a non-volatile memory device, such as Read-Only Memory (ROM), erasable programmable read-only memory (EPROM), or other suitable memory device or circuit as desired. Accordingly, such computer programs can represent controllers of the computing device.

In another exemplary embodiment, the program code, such as the node balancing protocol 400 and the node balancing programming 330A-B, can be provided in a computer program product having a non-transitory computer readable medium, such as Magnetic Storage Media (e.g. hard disks, floppy discs, or magnetic tape), optical media (e.g., any type of compact disc (CD), or any type of digital video disc (DVD), or other compatible non-volatile memory device as desired) and downloaded to the processor(s) for execution as desired, when the non-transitory computer readable medium is placed in communicable contact with the processor(s).

The one or more processors 162, 312, 352 can be included in a computing system that is configured with components such as memory, a hard drive, an input/output (I/O) interface, a communication interface, a display and any other suitable component as desired. The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, or any other suitable network communication interface as desired. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, or any other suitable communication link as desired.

Where the present disclosure is implemented using programming or software, including the node balancing protocol 400 and the node balancing programming 330A-B, the programming or software can be stored in a computer program product or non-transitory computer readable medium and loaded into the computing device using a removable storage drive or communications interface. In an exemplary embodiment, any computing device, such as control subsystem 110, control system 115 and controllers 170-173, disclosed herein can also include a display interface that outputs display signals to a display unit, e.g., LCD screen, plasma screen, LED screen, DLP screen, CRT screen, or any other suitable graphical interface as desired.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain”, “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element. Unless otherwise stated, the articles “a” or “an” preceding an element mean one or more of the elements.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “approximately” and “substantially” mean that the parameter value or the like varies up to ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

What is claimed is:

1. An energy storage system, comprising:
an energy storage node, including:
a plurality of battery storage elements, and
a control subsystem to receive battery data from the battery storage elements;
a power conversion system (PCS); and
a control system coupled to the energy storage node and the PCS;
wherein the control system, the control subsystem, or both are configured to:
receive or store battery charge and discharge characteristics of the battery storage elements during a plurality of operating conditions of the battery storage elements, the PCS, or both; and
run the battery storage elements of the energy storage node at one or more selected operating conditions of the plurality of operating conditions based on the battery charge and discharge characteristics to reduce an imbalance in state of charge among the battery storage elements of the energy storage node.

2. The energy storage system of claim 1, wherein the control system, the control subsystem, or both are configured to determine states of charge of each of the battery storage elements of the energy storage node from the battery data during the one or more selected operating conditions.

3. The energy storage system of claim 2, wherein the control system, the control subsystem, or both are configured to:
identify a first subset of battery storage elements at a different state of charge than a second subset of battery storage elements based on the determined states of charge.

4. The energy storage system of claim 3, wherein the running the battery storage elements of the energy storage node at the one or more selected operating conditions includes dispatching a required power flow across the first subset of battery storage elements and the second subset of battery storage elements of the energy storage node at the one or more selected operating conditions during a normal operation to reduce a mismatch in the states of charge between the first subset of battery storage elements and the second subset of battery storage elements.

5. The energy storage system of claim 4, wherein the one or more selected operating conditions include an operational bias during the normal operation.

6. The energy storage system of claim 3, wherein the running the battery storage elements of the energy storage node at the one or more selected operating conditions includes charging or discharging the first subset of battery storage elements and the second subset of battery storage elements of the energy storage node at the one or more selected operating conditions during a maintenance operation to reduce a mismatch in the states of charge between the first subset of battery storage elements and the second subset of battery storage elements.

7. The energy storage system of claim 1, wherein the plurality of operating conditions include a temperature, an electrical resistance, a current rate (C-rate), a current carrying capability, an eddy current, a conductance, a power pulse pattern during charging or discharging, other electrical characteristics, or a power command from the PCS.

8. The energy storage system of claim 1, wherein the running the battery storage elements of the energy storage node at the one or more selected operating conditions of the plurality of operating conditions based on the battery charge and discharge characteristics to reduce the imbalance in state of charge among the battery storage elements of the energy storage node includes:
selecting the one or more selected operating conditions of the plurality of operating conditions based on the battery charge and discharge characteristics to reduce the imbalance in the state of charge among the battery storage elements of the energy storage node; and
running the battery storage elements of the energy storage node at the one or more selected operating conditions.

9. The energy storage system of claim 8, wherein the selecting the one or more selected operating conditions of the plurality of operating conditions based on the battery charge and discharge characteristics to reduce the imbalance in the state of charge among the battery storage elements of the energy storage node includes:
applying one or more balancing models to the battery charge and discharge characteristics and the determined states of charge over one or more time periods; and
selecting the one or more selected operating conditions based on the applied one or more balancing models.

10. The energy storage system of claim 9, wherein the applying one or more balancing models to the battery charge and discharge characteristics and the determined states of charge over one or more time periods includes:
feeding the states of charge into one or more balancing models;
holding the states of charge over one or more time periods; and
matching the states of charge over the more time periods against operating condition patterns previously identified as being associated with reducing the imbalance in the determined states of charge.

11. A non-transitory computer-readable medium, comprising node balancing programming, wherein execution of the node balancing programming by one or more processors configures one or more controllers to:
receive or store battery charge and discharge characteristics of a plurality of battery storage elements of an energy storage node during a plurality of operating conditions of the battery storage elements, a power conversion system (PCS), or both; and
run the battery storage elements of the energy storage node at one or more selected operating conditions of the plurality of operating conditions based on the battery charge and discharge characteristics to reduce an imbalance in state of charge among the battery storage elements of the energy storage node.

12. The non-transitory computer-readable medium of claim 11, wherein execution of the node balancing programming by one or more processors configures one or more controllers to:
determine states of charge of each of the battery storage elements of the energy storage node from battery data during the one or more selected operating conditions.

13. The non-transitory computer-readable medium of claim 12, wherein execution of the node balancing programming by one or more processors configures one or more controllers to:
identify a first subset of battery storage elements at a different state of charge than a second subset of battery storage elements based on the determined states of charge.

14. The non-transitory computer-readable medium of claim 13, wherein the running the battery storage elements of the energy storage node at the one or more selected operating conditions includes dispatching a required power flow across the first subset of battery storage elements and the second subset of battery storage elements of the energy storage node at the one or more selected operating conditions during a normal operation to reduce a mismatch in the states of charge between the first subset of battery storage elements and the second subset of battery storage elements.

15. The non-transitory computer-readable medium of claim 14, wherein the one or more selected operating conditions include an operational bias during the normal operation.

16. A method, comprising:
receiving or storing battery charge and discharge characteristics of a plurality of battery storage elements of an energy storage node during a plurality of operating conditions of the battery storage elements, a power conversion system (PCS), or both; and
running the battery storage elements of the energy storage node at one or more selected operating conditions of the plurality of operating conditions based on the battery charge and discharge characteristics to reduce an imbalance in state of charge among the battery storage elements of the energy storage node.

17. The method of claim 16, further comprising:
determining states of charge of each of the battery storage elements of the energy storage node from battery data during the one or more selected operating conditions.

18. The method of claim 17, further comprising:
identifying a first subset of battery storage elements at a different state of charge than a second subset of battery storage elements based on the determined states of charge.

19. The method of claim 18, wherein the running the battery storage elements of the energy storage node at the one or more selected operating conditions includes dispatching a required power flow across the first subset of battery storage elements and the second subset of battery storage elements of the energy storage node at the one or more selected operating conditions during a normal operation to reduce a mismatch in the states of charge between the first subset of battery storage elements and the second subset of battery storage elements.

20. The method of claim 19, wherein the one or more selected operating conditions include an operational bias during the normal operation.
